(19) United States
(12) Patent Application Publication
(10) Pub. No.: US 2005/0057106 A1
(43) Pub. Date: Mar. 17, 2005

(54) Methods and systems for electric machines having windings

(75) Inventors: Timothy J. Allen, Cotham (GB); David Seniawski, Palo Alto, CA (US); Ziaur Rahman, Herndon, VA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems Corporation, Dearborn, MI (US)

(21) Appl. No.: 10/728,715

(22) Filed: Dec. 4, 2003

Related U.S. Application Data
(60) Provisional application No. 60/432,468, filed on Dec. 10, 2002.

(51) Int. Cl. H02K 9/00; H02K 9/20

(52) U.S. Cl. 310/54; 310/214; 310/254

(57) ABSTRACT

Apparatus and method for cooling and preventing the deterioration of the windings of an electric machine. The apparatus includes an electrically insulative spacer wedgingly disposed between adjacent windings.

### BACKGROUND OF THE INVENTION

1. Field of the Invention

The present systems and methods relate generally to electric machines.

2. Description of the Related Art

Electric machines, such as electric motors and generators, are used in many applications including those ranging from electric vehicles to domestic appliances. Improvements in electric machine performance, reliability, and power density for all types of electric machines are almost always desired. The presence of high power level electric machines results in high temperature operation, which causes distortions in the operating characteristics of the machines. In the absence of heat removal or some type of thermal liberation during machine operation, poor, degraded performance, and possibly total machine failure, can occur. As electronic device technology advances, there is a continuous reduction in component size while simultaneously calling upon these same components to handle increasingly greater levels of power. As component size decreases and power levels increase, higher operating temperatures result. The presence of elevated temperatures of electric machines is attended by a variety of operational difficulties and malfunctions, ultimately causing degraded machine performance and compromising reliability.

There are several conventional methods for cooling the components of electric machines. Natural convection cooling, for example, is a passive process involving the transfer of heat by the natural movement of air. Hot air tends to rise and is replaced by surrounding cooler, more dense air. Natural convection cooling using ambient air does have drawbacks; primarily, a relatively limited amount of heat can be effectively dissipated using this method. In many situations and applications of electrical machines, natural convection cooling does not allow for large enough amounts of heat to be removed at a rate necessary to avoid operational difficulties. In another conventional cooling method, electric machine or motor housings are designed to accommodate fluid cooling of the stator, but the thermal path from a concentrated winding through a stator tooth, and ultimately to the cooling fluid has a high thermal resistance due to a lack of contact surface area between the concentrated winding and the stator tooth.

As stated above, electric machines carry large currents to produce high power, which results in high operational temperatures. It is also known that lower machine operating temperatures result in increased machine efficiency. A lower machine temperature will allow more current to be carried by the machine windings, which in turn produces greater power output. The reliability of large high-voltage rotating machines is generally good, but experience has shown that when failure does occur, the most common electrical cause is the breakdown of stator winding insulation. Insulation failure in high-voltage machine windings may result in a sudden death event, such as an inter-turn fault. It is more likely, however, that a progressive degradation over time is experienced, which can be as short as a few months or as long as a term of years.

Various factors may operate singularly, or in combination to reduce the life expectancy of a stator winding insulation structure; and most of these factors can be expected to modify the discharge characteristic of the winding. All high-voltage stator windings generate partial discharge to some extent, but for a winding operating in good condition, the discharge energies are insufficient to give rise to any significant rate of discharge erosion.

Conventional winding construction methods, such as automated winding techniques like bobbin winding, result in winding movement. One of the most common sources of problems affecting modern high-voltage stator windings is movement of the winding under the influence of electromagnetic forces. Movement may take place either in the slots or in the end-winding regions, and bulging windings have a tendency to rub between adjacent phases that can lead to the deterioration of the insulation material and ultimately cause a phase-to-phase short.

What is needed is an apparatus that provides for the removal or allows dissipation of large quantities of heat from an electric machine's winding, while at the same time providing for the protection of the insulation material of the winding. The larger the quantity of heat removed or allowed to dissipate to the environment, and the better the physical condition of the insulation material, the more efficient the electric machine will be; and consequently, the larger the amount of current and power that the machine will be able to handle and produce.

### BRIEF SUMMARY OF THE INVENTION

At least one embodiment of the present systems and methods provides an apparatus for cooling and preventing deterioration of the windings of an electric machine. The apparatus includes a spacer wedgingly disposed between adjacent windings. The spacer is operable for increasing the surface area contact between the windings and a plurality (more than one, and preferably several) of stator teeth that provides a conductive and convective heat transfer path from the windings to a stator fluid cooling jacket. Additionally, this arrangement assists in preventing deterioration of winding insulation by preventing movement of the windings during load conditions.

In one embodiment, an electric machine apparatus, having a stator disposed within a housing that is operable for generating a magnetic field. A plurality of stator teeth is integrally formed with the stator and a fluid cooled jacket is operatively connected to the stator. A rotor is disposed within the housing and is configured to be operable for receiving the magnetic field and generating a torque. A plurality of windings are operatively connected to the stator and an electrically insulative spacer is disposed between the windings. The electrically insulative spacer is arranged to exert an outwardly perpendicular wedging force on the plurality of windings which in turn increases the surface area contact between the windings and the stator teeth. In this way, direct conductive and convective heat transfer paths from the plurality of windings to the fluid cooled jacket is established which adds thermal capacitance to the electric machine over similar capacity electric machines that are traditionally arranged. In this manner, local temperature fluctuations are reduced in the windings during transient load conditions and deterioration of the insulative material, which typically takes the form of a coating on the windings, is prevented, or at least reduced.

In another embodiment, the stator comprises a plurality of stator slots operable for fixably connecting the electrically insulative spacer to the stator and an adhesive disposed within the plurality of stator slots operable for fixably connecting the electrically insulative spacer to the stator.

In another embodiment, a method for transferring heat from a plurality of windings of an electric machine includes disposing an electrically insulative spacer between the plurality of windings thereby reducing the distance between the plurality of windings and a plurality of stator teeth. An increasing of the surface area contact between the plurality of windings and the plurality of stator teeth is also effected by implementation of the method.

In another embodiment, the electrically insulative spacer is tapped in between the plurality of windings. In this regard, adjacent windings are typically spaced apart at certain distances. It is into this interstitial space that such an insulative spacer is tap-inserted or installed.

In another embodiment, the electrically insulative spacer exerts an outwardly perpendicular wedging force on a plurality of windings of an electric machine. This press-fit establishes direct conductive and convective heat transfer paths from the windings to the stator teeth, and ultimately to a fluid cooled jacket that is functionally connected to the teeth. This results in an increase of the surface area contact between the plurality of windings and the plurality of stator teeth. It further prevents the deterioration of any insulation material taking the form of a coating of the machine's windings.

In another embodiment, an electric machine includes but is not limited to: a first stator winding and a second stator winding; and a spacer between and in contact with the first stator winding and the second stator winding.

In another embodiment, a method for use with an electric machine includes but is not limited to: applying an external force to deform a stator winding toward a surface of a stator tooth.

In another embodiment, a method includes but is not limited to: providing a thermal path to a heat sink by placing a spacer in physical contact with at least two windings of an electric machine.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the devices and/or processes described herein, as defined solely by the claims, will become apparent in the non-limiting detailed description set forth herein.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is an end-on schematic view of an electric machine, taken in partial cut-away, showing a stator that includes spacers disposed between adjacent windings.

FIG. 2 is a schematic illustration of a plurality of windings functionally connected to a plurality of stator teeth of an electric machine without the spacers of the present systems and methods.

FIG. 3 is a similar schematic to that of FIG. 2, but insulative spacers are positioned interstitially between the windings.

FIG. 4 is a schematic illustration of an electric machine showing spacers disposed between adjacent windings according to the presently disclosed systems and methods.

### DETAILED DESCRIPTION OF THE INVENTION

As required, detailed embodiments of the present systems and methods are disclosed herein, however, it is to be understood that the disclosed embodiments are merely exemplary of the systems and methods that may be embodied in various and alternative forms. Specific structural and functional details disclosed herein are not to be interpreted as limiting, but merely as a basis for the claims and as a representative basis for teaching one skilled in the art to variously employ the present systems and methods.

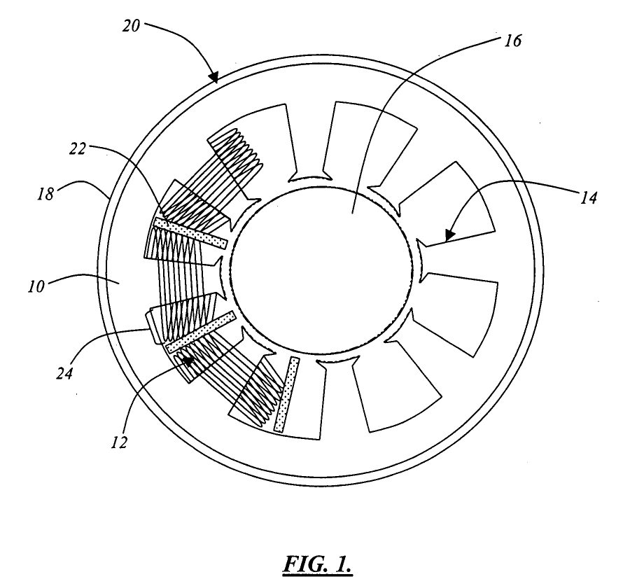

Referring to FIG. 1, shown is an end-on schematic view of an electric machine, taken in partial cut-away, showing a stator 10 that includes a plurality of spacers 22 (which may be of an electrically insulative and thermally conductive material) disposed between adjacent windings 12 on a plurality of stator teeth 14. The stationary housing containing the coil-wound poles establishes the stator 10. In one embodiment, the stator is at least partially formed from iron. A winding 12, also referred to as a coil 12, is made up of several turns of copper wire wound on a stator tooth 14. The winding 12 is formed by winding an enameled wire around a core with a predetermined electrical specification. The wire is coated with an enameled coating which functions as an insulator. Passing an electric current through the winding 12 from the outside generates an electromagnetic force that rotates a rotor 16. The winding 12 consists of intimately wound wire and may be wrapped with epoxy to avoid flexing. The nature and configuration of the winding(s) 12 is what differentiates one electric machine from the next, and has a great deal to do with the performance of the machine. A machine housing 18 may include a fluid cooled jacket 20, which is wrapped around the stator's 10 outer surface. The purpose of the fluid cooled jacket 20 is to transfer heat dissipated from the windings 12 through the stator teeth 14 and then away from the electric machine using fluid that is circulated through the fluid cooled jacket 20.

In a preferred embodiment, an electrically insulative spacer 22 is disposed between two adjacent windings 12 and is affixed (e.g., glued) to a surface of the stator 10. The electrically insulative spacer 22 provides an outward and substantially perpendicular force on the adjacent winding(s) 12. This modification reduces by compaction the generally rounded mass 24 of wire that extends out from the stator tooth 14 about which the wire is wound.

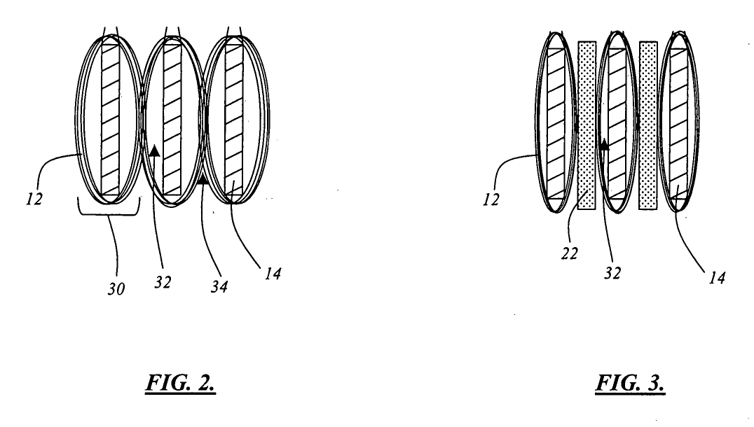

Referring to FIG. 2, depicted is a side-plan schematic illustration of three windings 12 functionally connected to three stator teeth 14 of an electric machine, but without the electrically insulative spacers 22 of FIG. 1. In the absence of the electrically insulative spacers 22 of FIG. 1, the concentrated windings 12 will tend to protrude out from the stator tooth 14 creating a rounded mass 30. In the absence of the electrically insulative spacers 22 (FIG. 1), an air gap 32 is disposed between the winding 12 and stator tooth 14. Those having ordinary skill in the art will appreciate that air gap 32 is often formed during a winding process, and is formed at least partially because of the rigidity of the wire used to establish the windings 12.

As shown, in the absence of the electrically insulative spacers 22 of FIG. 1, adjacent windings 12 contact one another at potential abrasion zones 34, especially where the windings 12 protrude from the stator teeth 14 such that air gaps 32 are largest. This contact often leads to the deterioration of the insulation coating on the adjacent windings 12. As stated above, the deterioration of the insulation material may ultimately lead to a phase-to-phase short. Conventionally, when machine failure does occur, the most common electrical cause is the deterioration of the insulation on the wire of the stator windings 12. Physical contact between adjacent windings 12 often results in the progressive degradation of the insulation coating of the windings 12 over a period of time, which may be as short as a few months or as long as tens of years.

Referring now to FIG. 1 and FIG. 2, those having ordinary skill in the art will appreciate that, in operation, the stator windings 12 of FIG. 2 often move under the influence of electromagnetic forces. The electrically insulative spacer 22 of FIG. 1 is designed to prevent excessive movement in the presence of electromagnetic forces due to current flow in adjacent windings.

Continuing to refer to FIG. 1 and FIG. 2, those having ordinary skill in the art will appreciate that, as an electric machine having stator windings 12 such as those shown in FIG. 2 is subjected to frequent severe starting duty, there is a tendency for some limited freedom of movement to develop, with the possibility that resultant flexing of the windings may lead to fatigue failure of the insulation structure and the onset of internal discharge, especially since the natural forces exerted on the winding sides in the stator slot are such as to push the winding sides towards each other. The insulative spacer 22 of FIG. 1 alleviates such flexing problems by providing a wedging force that does not allow the windings any significant freedom to move in an outward manner perpendicular to a long axis of the stator tooth 14 about which the winding is formed. Consequently, the potential for tangential movement of the winding sides in the slots of the stator 20 such as shown in FIG. 2 can be significantly reduced due to the insertion of the insulative spacer 22.

Continuing to refer to FIG. 1 and FIG. 2, those having ordinary skill in the art will appreciate that tangential movement of the windings in the slots of the electric machine of FIG. 2 should not normally be possible, but if movement is permitted as a consequence of loose slot wedges, then the stator teeth 14 may be forced into a tangential vibration mode as a result of magnetic interaction with other stator teeth 14. With respect to FIG. 2, since sides of the winding 12 make contact with walls of the slot at various points along the slot's length, the same vibration frequency will be transmitted to the winding's 12 sides. The electrically insulative spacer 22 of FIG. 1 alleviates such flexing problems by providing a wedging force that significantly reduces these vibrations when properly installed. In addition, if there is a vibration in a stator tooth 14, the wedging force provided by the insulating spacer 22 will significantly reduce the vibration.

Continuing to refer to FIG. 1 and FIG. 2, those having ordinary skill in the art will appreciate that a winding 12 of the electric machine shown in FIG. 2, having sections in which the insulation material has been abraded away, may lead to a phase-to-phase short. The insulative spacer 22 of FIG. 1 reduces the likelihood of such phase-to-phase discharges both by preventing the deterioration of the insulating material of the winding 12 and reducing the possibility of an inter-winding short circuit.

Referring now again to FIG. 2, as stated above, in the absence of the electrically insulative spacers 22, significant air gaps 32 often exist between the windings 12 and the stator teeth 14. These gaps 32 often hinder heat transfer from the winding 12 to the stator tooth 14.

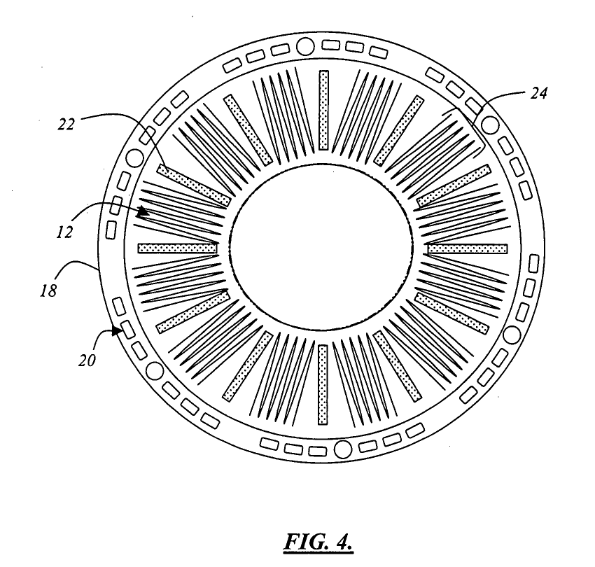

Referring to FIG. 3, illustrated is the side-plan schematic illustration of three windings 12 functionally connected to the three stator teeth 14 depicted in FIG. 2, wherein the electrically insulative spacers 22 of FIG. 1 have been placed. Shown is that, in comparison with the structure shown in FIG. 2, the presence of the electrically insulative spacers 22 gives rise to a significantly reduced air gap 32. As shown, the presence of the electrically insulative spacers 22 between adjacent windings 12 provides an outward and substantially perpendicular force on the adjacent windings 12. Comparison of the structure of FIG. 3 with that of FIG. 2 shows that the electrically insulating spacers 22 are now occupying a volume previously occupied by the windings 12 as shown in FIG. 2. Consequently, as shown by comparison of the structure of FIG. 3 with that of FIG. 2, the presence of the electrically insulating spacers 12 pushes a portion of the windings 12 into closer proximate to stator tooth 14, and can in fact increase surface area contact between the winding 12 and the adjacent stator tooth 14 if electrically insulating spacers 22 displace enough volume to actually press windings 12 against the stator teeth 14. As can be seen by comparison of the structures of FIG. 3 and FIG. 2, the presence of insulating spacers 22 results in a reduction of the air gap 32 between the winding 12 and the stator tooth 14. By reducing the air gap 32 and increasing the surface contact area of the winding 12 and the stator tooth 14, the heat transfer path from the winding 12 to the stator tooth 14, and ultimately to the stator cooling jacket, is enhanced and made more direct. A more direct heat transfer path results in an increase in the amount of heat that is able to be removed from the windings 12.

In one embodiment, an electrically insulative spacer 22 is inserted into slots disposed between the plurality of stator teeth 14. In one embodiment, the insulative spacer 22 is inserted into a slot from one end of the electric machine by tapping the spacer 22 into the space between two adjacent windings 12. The insulative spacer 22 is then glued to hold it securely in place and prevent movement. In one embodiment, insulative spacers 22 may comprise a composite sheet material based on laminated textile sheets with an epoxy matrix. A slot may not be specifically shaped over the requirements for the electromagnetic design. The thickness of spacer 22 may be directly proportional to a copper slot fill factor. The spacers 22 may be dimensioned to be the total slot depth, an appropriate thickness based on the slot fill, and overhang the slot and winding 12 axially.

In light of the explanations and comparisons of FIG. 2 and FIG. 3, the operation and some of the advantages of the electric machine of FIG. 1 can now be discussed in greater detail.

Referring now again to FIG. 1, during operation of the electric machine, as heat is generated in the stator windings 12 during load conditions, it is desirable to remove the heat from the windings 12. Accordingly, the fluid cooled jacket 20 is operable for transferring heat from the stator 10 via a thermal path from a winding 12 through the stator 10, and ultimately to the cooling fluid. The fluid cooled jacket 20 causes accelerated convective heat transfer.

Those having ordinary skill in the art will appreciate that accelerated convective heat transfer is the flow of heat from the hot molecules on the surface of the stator 10, to the cold molecules of the fluid cooled jacket 20. The cooler the fluid cooled jacket 20, the greater the heat transfer. Increased dissipated heat transfer allows the electric machine to be operated at higher speeds than it could otherwise tolerate.

In one embodiment (where one or more of the insulative spacers are in thermal communication with stator 10 either through an air gap or direct contact (not shown)), the surface contact area between the winding 12 and the insulative spacer 22 provides a direct conductive and convective heat transfer path from the winding 12 through the lamination stack of the stator 10, to the fluid cooled jacket 20 surrounding the lamination stack of the stator 10. In another embodiment, the insulative spacer 22 aids in cooling the winding 12 by providing a path of lower thermal resistance from the lamination stack of the stator 10 to the fluid cooled passages disposed within the cooling jacket 20 by bringing the windings 12 into closer proximity to their stator teeth. One benefit of the foregoing is that the insulative spacers 22 add thermal capacitance to the electric machine, which can reduce local temperature fluctuations in the windings 12 during transient load conditions. Another benefit is that the use of the insulative spacers 22 of the present systems and methods, as opposed to an active cooling strategy, such as spraying oil, is that the spacers 22 exert little mechanical pressure, thereby preventing erosion of the winding's 12 varnish or insulation which would tend to occur in the absence of the insulative spacers 22.

As used herein, a layer where the cool surfaces of the insulative spacers 22 and the stator teeth 14 meet the hot surface of the winding 12 is called a boundary layer. In one embodiment, these layers tend to be very thin, and hence the heat from the winding 12 is transferred very easily. One benefit of the present systems and methods is that the increased surface contact areas increase the boundary layers. Consequently, extremely high heat transfer coefficients are obtained within a stagnation zone. Since the peak heat transfer only occurs within the stagnation zone, a surface area of greater contact provides an effective means where highly localized cooling is required, such as at the windings 12.

Those skilled in the art will appreciate that as the temperature of a winding 12 approaches an end limit, usually in the range of 150-195° C., and preferably in the range of 150-180° C., the amount of current that may be supplied to the electric machine is limited. One benefit of using the insulative spacer 22 in some embodiments is that the temperature of a winding 12 is lowered to around 150° C., or less, so that more current may be supplied to the machine. Those having ordinary skill in the art will appreciate that the more current that is supplied to the machine, the more power the machine is able to generate, and the more torque the machine is able to produce. Current is directly proportional to torque, and is referred to herein as power density. In some embodiments, the insulative spacer 22 apparatus of the present systems and methods increases an electric machine's power density by increasing the capability for accepting higher currents without detrimental effects or degradation.

Those having ordinary skill in the art will appreciate that with natural convection cooling using stagnant air, in the absence of insulative spacers 22, as the air around the surface of a winding 12 approaches and equals the temperature of the winding 12 itself, heat is no longer able to be transferred from the winding 12 to the surrounding air because the temperatures are equal. Heat transfers via a path of minimum resistance, hot to cold, and there is no benefit in traveling on a path to an equal temperature. Consequently, in some embodiments, the insulative spacers 22 of the present systems and methods provide a path with a lower thermal resistance as compared to conventional winding 12 cooling methods.

As noted, in some embodiments the insulative spacer 22 of the present systems and methods results in lower temperatures of a stator winding 12 of an electric machine, which results in increased machine reliability. Those skilled in the art will appreciate that, as winding 12 temperatures rise above a certain level, around 150-195° C., the performance and reliability of electric machines, such as motors and generators, is limited. Those skilled in the art will also appreciate that lower winding temperatures translate into higher machine performance, higher power density, and improved reliability of the machine. For a constant power rating, a machine with the cooling method of the present systems and methods may be significantly smaller in size, lower in weight, and cost less than a machine with a conventional cooling method.

In some embodiments, cooling and preventing the deterioration of the insulation material of the windings 12 allows for greater voltage to be produced in the stator 10. The reduction of the heat radiating from the stator 10 causes a reduction in the temperature of the windings 12, which lowers the resistance of the windings 12. Resistance and inductance are the two inherent physical properties of a winding 12. These two factors limit the possible performance of the electric machine. The resistance of the winding 12 is responsible for the power loss and heat generated in the machine. Inductance makes the winding oppose current changes and therefore limits high speed operation of the machine. Size and thermal characteristics of the windings 12 and the machine limit the maximum allowable power dissipated in the windings 12.

In some embodiments a higher voltage and lower resistance reduces the current for a given kilowatt output or load. Since the efficiency and life of many power electronics is inversely proportional to current, the insulative spacer 22 apparatus increases the efficiency of the electric machine application as a whole, and increases the life of the magnets, stator windings 12, power electronics, and other components sensitive thereto. Cooling the stator windings 12 to a lower operating temperature also improves the reliability and robustness of the electric machine application by increasing the operating margin of the application as a whole, and is particularly important at higher ambient temperatures.

Referring to FIG. 4, shown is an end-on schematic view of an alternate version of the electric machine of FIG. 1. Shown is that, in one embodiment, an electric machine includes a machine housing 18, a plurality of windings 12 forming rounded masses 24, a fluid-cooled jacket 20 and a plurality of electrically insulted spacers 22 disposed between adjacent windings 12. The alternate embodiment of FIG. 4 functions substantially similarly to the foregoing described embodiments, and yields similar advantages. For the sake of brevity, such functioning and advantage will not be reiterated here, in that understanding such functioning and advantages is well within the ambit of one having ordinary skill in the art in light of the teachings set fort above.

As was apparent above, the electrically insulative spacer apparatus 22 of the present systems and methods does not interfere with the primary function of electric machines. As noted, the rotor 16, and all other components of the electric machines discussed herein may be of conventional function (thereby allowing retrofitting to existing electric machines). Moreover, the electrically insulative spacer 22 does not block or prevent the cooling of the rotor 16.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with”each other such that the desired functionality is achieved, irrespective of architectures or intermedial components. Likewise, any two components so associated can also be viewed as being “operably connected”, or “oerably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the terms “including” and “comprising” should be interpreted as “including but not limited to,” the term “having” should be interpreted as “having at least,” the terms “includes” and “comprises” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

1. An electric machine, comprising:
a stator comprising a plurality of stator teeth;
a rotor mounted for rotation with respect to the stator a first stator winding carried by a first one of the stator teeth and a second stator winding carried by a second one of the stator teeth; and
a spacer received between and in contact with the first stator winding and the second stator winding.

2. The electric machine of claim 1 wherein the spacer is of a sufficient thickness to displace at least one of the first stator winding and the second stator winding.

3. The electric machine of claim 1 wherein spacer is of a sufficient thickness to displace at least one of the first stator winding and the second stator winding toward a respective one of the stator teeth that carries the respective one of the first and the second stator windings with respect to an undisplaced position.

4. The electric machine of claim 1 wherein the spacer is in at least one of conductively thermal and convectively thermal contact with a fluid cooled jacket.

5. The electric machine of claim 1 wherein the spacer comprises an electrically insulative and thermally conductive material.

6. The electric machine of claim 1, further comprising:
a fluid cooled jacket integral with a stator.

7. The electric machine of claim 1 wherein the spacer comprises a composite sheet material formed from a number of laminated textile sheets comprising an epoxy matrix.

8. The electric machine of claim 1, further comprising:
a stator slot formed between the first and the second stator teeth; and
an adhesive received in the stator slot in contact with the spacer.

9. A method for use with an electric machine, comprising:
applying an external force to deform a stator winding toward a surface of a stator tooth while the electric machine is in use.

10. The method of claim 9 wherein the applying an external force to deform a stator winding toward a surface of a stator tooth comprises interposing a spacer between a first stator winding and a second stator winding.

11. The method of claim 10 wherein the interposing a spacer between a first stator winding and a second stator winding comprises tapping the spacer into place.

12. The method of claim 10 wherein the interposing a spacer between a first stator winding and a second stator winding further comprises:
applying an adhesive to the spacer.

13. The method of claim 9 wherein the applying an external force to deform a stator winding toward a surface of a stator tooth comprises:
pushing at least a portion of the stator winding into direct physical contact with the stator tooth.

14. A method comprising:
providing a stator comprising a plurality of stator teeth;
mounting a rotor for rotation with respect to the stator;
wrapping a first stator winding about at least a portion of a first one of the stator teeth;
wrapping a second stator winding about at least a portion of a second one of the stator teeth; and
placing a spacer in physical contact with at least two the first and the second stator windings of an electric machine to provide a thermal path to a heat sink.

15. The method of claim 14 wherein placing a spacer in physical contact with at least the first and the second stator windings of an electric machine comprises placing the spacer in at least one of a conductive and a convective thermal communication with the heat sink.

16. The method of claim 14 wherein placing a spacer in physical contact with at least the first and the second stator windings of an electric machine comprises placing the spacer such that at least one of the first and the second stator windings of the electric machine is moved into nearer thermal proximity to the heat sink.

17. The method of claim 14 wherein placing a spacer in physical contact with at least the first and the second stator windings of an electric machine comprises placing the spacer such that at least one of the first and the second stator windings is moved into closer physical proximity with a surface of the respective one of the first and the second stator tooth around which the stator winding is wrapped.

18. The method of claim 14 wherein the heat sink comprises a fluid cooled jacket.
